(19) United States
(12) Patent Application Publication
(10) Pub. No.: US 2026/0085933 A1
(43) Pub. Date: Mar. 26, 2026

(54) BLIND SOURCE SEPARATION FOR MAGNETIC ANOMALY NAVIGATION

(71) Applicant: Honeywell International Inc., Charlotte, NC (US)

(72) Inventors: Umut Orhan, Bothell, WA (US); Trevor Keith Stephens, Maple Grove, MN (US)

(73) Assignee: Honeywell International Inc., Charlotte, NC (US)

(21) Appl. No.: 19/212,193

(22) Filed: May 19, 2025

Related U.S. Application Data
(60) Provisional application No. 63/699,429, filed on Sep. 26, 2024.

(51) Int. Cl. G01C 21/08

(52) U.S. Cl. CPC G01C 21/08

(57) ABSTRACT

A system comprises a vehicle; an onboard navigation processing unit including an Earth magnetic model, a sensor compensation module, a navigation filter, and a magnetic anomaly map storage; and a plurality of onboard magnetometers in communication with the sensor compensation module and spatially separated from each other. The navigation filter hosts one or more magnetic anomaly navigation algorithms. The sensor compensation module has program instructions for performing a method to provide enhanced magnetic anomaly navigation, comprising performing data acquisition by recording temporally synchronized magnetometer measurements; and performing blind source separation with a set of constraints including a far-field assumption, and spatial coherence. The method further comprises performing interference source elimination to zero out or reduce irrelevant interference sources; reconstructing the signal of interest to generate enhanced magnetic field measurements; and feeding the enhanced magnetic field measurements to the one or more magnetic anomaly navigation algorithms in the navigation filter.

### CROSS REFERENCE TO RELATED APPLICATION

This application claims the benefit of and priority to U.S. Provisional Application No. 63/699,429, filed on Sep. 26, 2024, the disclosure of which is herein incorporated by reference.

### BACKGROUND

Magnetic anomaly navigation is a global navigation satellite system (GNSS)-denied navigation technique, in which measurements of magnetic anomalies are compared with geo-located magnetic anomaly maps. The performance of magnetic anomaly navigation is heavily dependent on the signal quality of magnetometers on a vehicle. The signals from magnetometers are often degraded by various interferences and electromagnetic noises, including those induced by a metal structure of the vehicle interacting with the Earth's magnetic field.

While traditional methods like Tolles-Lawson equations have been employed to mitigate some of these interferences, such methods are insufficient in eliminating all unintended disturbances. This problem is compounded by additional interference sources that are difficult to characterize or estimate, such as weather effects and electrical noise from vehicle systems such as avionics systems.

The foregoing issues significantly impact the accuracy and reliability of magnetic anomaly navigation, potentially compromising its effectiveness in critical GNSS-denied scenarios.

### SUMMARY

A system comprises a vehicle; a navigation processing unit onboard the vehicle, the navigation processing unit including an Earth magnetic model, a sensor compensation module, a navigation filter, and a magnetic anomaly map storage; and a plurality of magnetometers onboard the vehicle and in operative communication with the sensor compensation module, the magnetometers spatially separated from each other. The navigation filter hosts one or more magnetic anomaly navigation algorithms, the navigation filter in operative communication with the sensor compensation module and the magnetic anomaly map storage. The sensor compensation module hosts a program module having instructions for performing a method to provide enhanced magnetic anomaly navigation for the vehicle. The method comprises performing data acquisition by recording temporally synchronized magnetometer measurements from the magnetometers; and performing blind source separation with a set of constraints including: a far-field assumption, in which a signal of interest that includes Earth magnetic field and a magnetic anomaly, is assumed to be measured quasi-identically across the magnetometers; and spatial coherence, which exploits known spatial relationships between the magnetometers to differentiate between global and local interference sources. The method further comprises performing interference source elimination to zero out or reduce irrelevant interference sources; reconstructing the signal of interest to generate enhanced magnetic field measurements; and feeding the enhanced magnetic field measurements to the one or more magnetic anomaly navigation algorithms in the navigation filter.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system that can implement blind source separation techniques to provide enhanced magnetic anomaly navigation for a vehicle, according to one embodiment;

FIG. 2 is an example of a geo-located magnetic anomaly map, which can be employed in the system of FIG. 1;

FIG. 3 is a flow diagram of a method for implementing blind source separation techniques to provide enhanced magnetic anomaly navigation for a vehicle;

FIG. 4A is a graph of simulated magnetometer measurements with respect to time, showing additive pulse noise signals over a true anomaly signal;

FIG. 4B is a graph of simulated magnetometer measurements with respect to time, showing denoising of the pulse noise signals of FIG. 4A using blind source separation techniques;

FIG. 5 shows a set of graphs of simulated original sources, including Earth field along trajectory, true anomaly over trajectory, and electromagnetic interference sources from a vehicle;

FIG. 6 shows a set of graphs of simulated magnetometer outputs, based on the simulated original sources of FIG. 5; and

FIG. 7 shows a first set of graphs that represent simulated recovered sources, some of which were used for signal reconstruction to generate enhanced magnetic field measurements represented by a second set of graphs.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A system and method for applying blind source separation (BSS) techniques to magnetic anomaly navigation, are described herein. The present approach utilizes multiple magnetic sensors and signal processing algorithms, to effectively separate and eliminate various interference sources from a signal of interest. This approach can significantly enhance the quality of magnetometer measurements, thereby improving the overall performance and reliability of magnetic anomaly navigation systems.

The present approach applies constrained BSS techniques to enhance magnetic anomaly navigation by effectively isolating and removing interference from magnetometer signals. The BSS techniques are signal processing methods that separate a set of mixed source signals into their original components, without prior knowledge of the mixing process or the source signals themselves.

While BSS methods are typically used in audio and biosignal processing, the present approach adapts these methods to the unique challenges of magnetic field measurements in navigation. In magnetic anomaly navigation, the Earth's magnetic field (including anomalies) represents the signal of interest, while various interference sources (e.g., from a vehicle's own systems or external electromagnetic noise) contaminate this signal. By applying BSS methods, these mixed signals can be separated to isolate clean magnetic field data that is needed for accurate navigation.

The present method can be implemented as a software module that integrates with existing vehicle navigation systems. The method processes raw magnetometer data in real-time, leveraging the constrained BSS approach to provide clean, enhanced magnetic field measurements to the navigation algorithms. The method separates the signal of interest from interference signals using a set of constraints that exploit the known characteristics of the Earth's magnetic field and sensor array geometry.

The present approach provides improvements in GNSS-denied navigation accuracy and reliability, and can provide a cost-effective enhancement of existing navigation systems through software algorithms.

In one embodiment of the present system, a sensor array is deployed that includes multiple magnetometers with spatial separation on a navigation platform. The magnetometer placement is optimized to capture both the Earth's magnetic field and potential interference sources. During data acquisition, the system simultaneously records high sampling rate measurements from the magnetometers, and ensures precise temporal synchronization across the magnetometers. An optional preprocessing step can be employed to apply initial filtering to remove high frequency noise and direct current (DC) offsets, and to normalize data across all sensors for BSS algorithm compatibility.

A constrained blind source separation step is then performed on the acquired data, which can be implemented using Independent Component Analysis (ICA) or other suitable BSS algorithms. The known constraints utilized include: far-field assumption, in which the signal of interest (Earth's magnetic field and magnetic anomaly) is assumed to be measured quasi-identically across the magnetometers due to its far-field nature; and spatial coherence, which exploits the known spatial relationships between magnetometers to differentiate between global (signal of interest) and local interference sources. As used herein, the term “quasi-identically” means that signals that are nearly identical across sensors in shape, timing, and amplitude due to a common far-field source, can be treated as functionally equal. In a signal reconstruction step, the imposed constraints are leveraged to isolate the signal of interest, and a clean magnetic field signal is reconstructed using components that satisfy the constraints to produce enhanced magnetic field measurements. Integration with a vehicle navigation system then occurs by feeding the enhanced magnetic field measurements into existing magnetic anomaly navigation algorithms in the vehicle navigation system.

The present system can be used in real-time processing such that the BSS algorithm operates in real-time on streaming sensor data. Efficient computational techniques can be utilized to minimize latency and ensure timely output for navigation purposes. For example, sliding window approaches or recursive updating methods can be employed to continuously process incoming data.

In optional features for the present approach, a source classification step can be implemented to further refine the separation of sources using machine learning techniques for automated classification of signals of interest and interference sources. In addition, a deep learning-based technique can be employed, in which a neural network is used to perform the BSS while respecting defined constraints. If source classification is included, the neural network can be extended to perform this function as well. In addition, the neural network architecture can be optimized for real-time inference on navigation hardware. Further, sensor measurement fusion can be used to include data from other onboard sensors to improve signal separation accuracy in real-time.

Further details of various embodiments are described hereafter and with reference to the drawings.

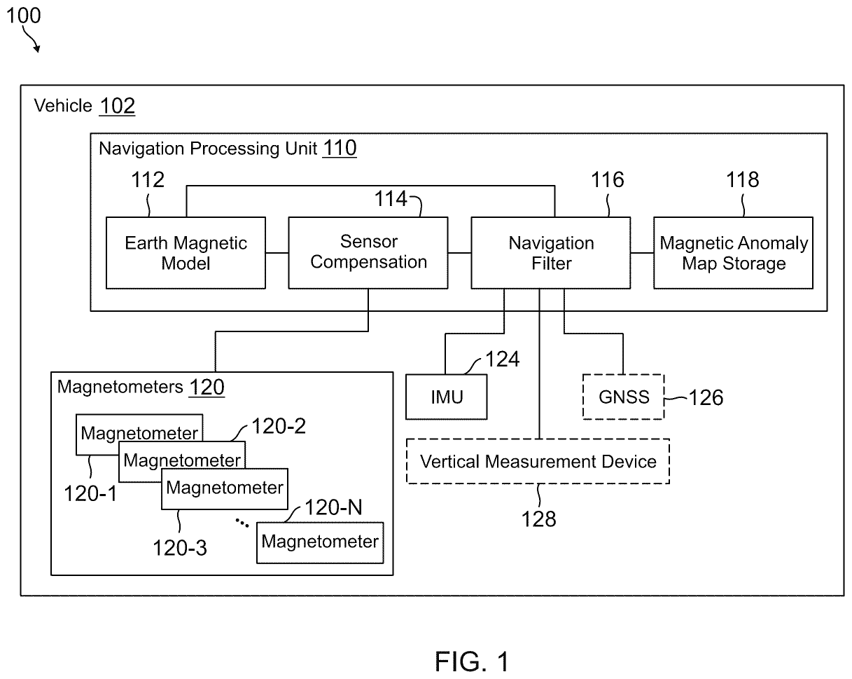

FIG. 1 is a block diagram of a system 100 according to one embodiment, which can implement blind source separation techniques to provide enhanced magnetic anomaly navigation for a vehicle 102. The system 100 comprises a navigation processing unit 110, which generally includes an Earth magnetic model 112, a sensor compensation module 114, a navigation filter 116, and a magnetic anomaly map storage 118. The vehicle 102 can be an aerial vehicle, a ground vehicle, a water vehicle, or the like. For example, the vehicle 102 can be a crewed aircraft, an uncrewed aircraft, a ship, a submarine, or the like.

A plurality of magnetometers 120 are onboard the vehicle 102 and operatively communicate with the sensor compensation module 114. For example, an array of magnetometers 120-1, 120-2, 120-3 . . . 120-N can be deployed at different locations on the vehicle 102 so as to have a spatial separation that is optimized to capture both the Earth's magnetic field and potential interference sources. In one embodiment, the magnetometers 120 include magnetometry structures using nitrogen-vacancy centers in diamond.

In addition, one or more aiding sensors can be onboard the vehicle 102 and in operative communication with the navigation filter 116, to provide additional sensor measurements. For example, an inertial measurement unit (IMU) 124 can be mounted on the vehicle 102 and operatively communicates with the navigation filter 116. The IMU 124 includes one or more gyroscopes and one or more accelerometers, such as micro-electromechanical systems (MEMS) gyroscopes and MEMS accelerometers. Other aiding sensors can optionally be onboard the vehicle 102 and in operative communication with the navigation filter 116. Examples of these other aiding sensors can include a global navigation satellite system (GNSS) receiver 126, and a vertical measurement device 128 such as an altimeter.

The Earth magnetic model 112 includes an estimated Earth magnetic field such as from the World Magnetic Model. The Earth magnetic model 112 operatively communicates with the sensor compensation module 114 and the navigation filter 116. The magnetic anomaly map storage 118 contains various magnetic anomaly maps and other data, such as the North American Magnetic Anomaly Database (NAMAD), the Earth Magnetic Anomaly Grid (EMAG), or the like. The magnetic anomaly map storage 118 operatively communicates with the navigation filter 116. The sensor compensation module 114 hosts a program module having instructions for performing a blind source separation (BSS) algorithm. The sensor compensation module 114 operatively communicates with the navigation filter 116. The navigation filter 116 is operative to fuse measurements from the various sensors onboard the vehicle 102, and hosts one or more magnetic anomaly navigation algorithms.

During operation of the system 100, data acquisition is performed by simultaneously recording high-sampling-rate measurements obtained from the magnetometers 120, while ensuring precise temporal synchronization across the magnetometers 120. The acquired data is sent to the sensor compensation module 114 for processing by the BSS algorithm. In one implementation, a constrained BSS algorithm is used, such as ICA. The constrained BSS algorithm incorporates the following constraints: far-field assumption, in which the signal of interest (Earth's magnetic field and magnetic anomaly) is assumed to be measured quasi-identically across the magnetometers 120 due to its far-field nature; and spatial coherence, which exploits the known spatial relationships between the magnetometers 120 to differentiate between global (signal of interest) and local interference sources. Signal reconstruction is then performed, in which the imposed constraints are leveraged to isolate the signal of interest. A clean magnetic field signal is reconstructed using components that satisfy the constraints to provide enhanced magnetic field measurements, which are fed to the navigation filter 116 for use by the magnetic anomaly navigation algorithm to provide navigation guidance for the vehicle 102.

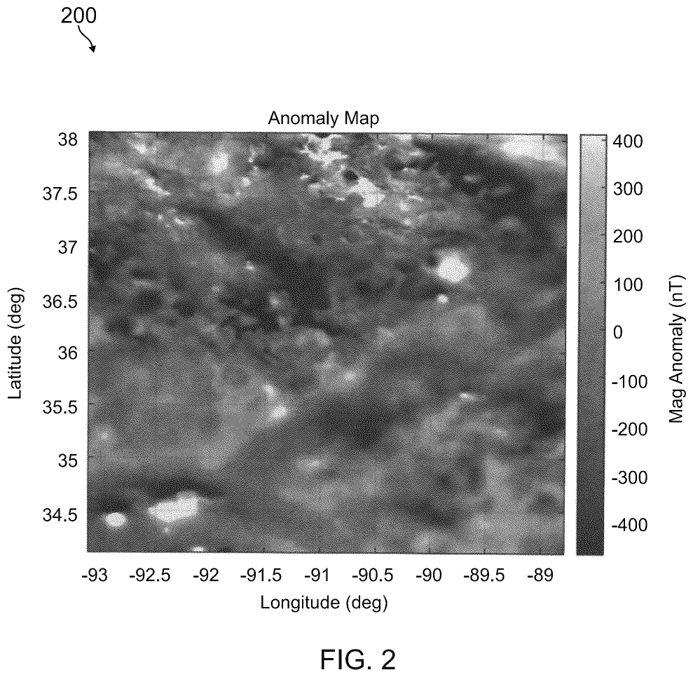

FIG. 2 is an example of a geo-located magnetic anomaly map 200, which can be employed in the present system, such as system 100 where magnetic anomaly map 200 can be contained in the magnetic anomaly map storage 118. The magnetic anomalies shown in the magnetic anomaly map 200 are variations in the crustal field of the Earth due to permanent or induced magnetized rock. The magnetic anomalies are useful for navigation because they are stable over time and exhibit high spatial frequency content. The magnetic anomaly map 200 is for a given geographical region of latitude and longitude.

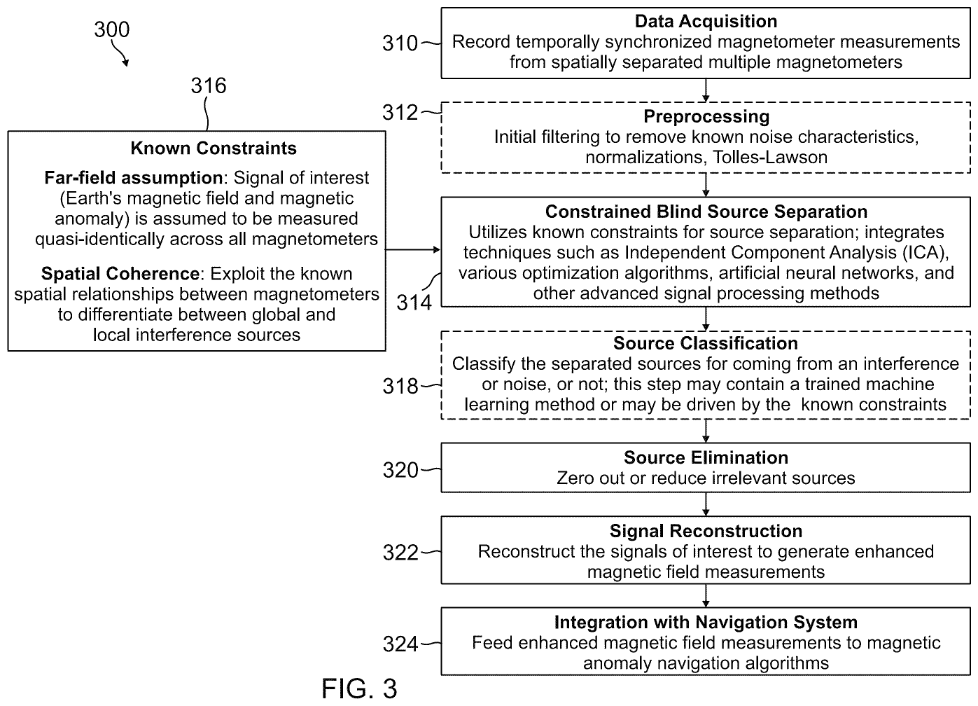

FIG. 3 is a flow diagram of a method 300 for implementing blind source separation techniques to provide enhanced magnetic anomaly navigation for a vehicle. The method 300 includes a data acquisition step 310, which obtains and records temporally synchronized magnetometer measurements from spatially separated multiple magnetometers on the vehicle. In an optional preprocessing step 312, the method 300 can perform initial filtering to remove known noise characteristics, perform normalizations of the magnetometer measurements, and utilize Tolles-Lawson equations to mitigate some signal interference.

The method 300 then performs a constrained blind source separation step 314, which utilizes a set of known constraints 316 for source separation. The known constraints 316 include far-field assumption, in which the signal of interest (Earth's magnetic field and magnetic anomaly) is assumed to be measured quasi-identically across the magnetometers; and spatial coherence, which exploits the known spatial relationships between the magnetometers to differentiate between global and local interference sources. The constrained blind source separation step 314 can integrate various techniques such as ICA, various optimization algorithms, artificial neural networks, and other advanced signal processing methods.

In an optional source classification step 318, the method 300 can classify the separated interference sources as coming from an interference source or noise, or not. This step may contain a trained machine learning algorithm, or may be driven by the known constraints.

The method 300 then performs an interference source elimination step 320 to zero out or reduce irrelevant interference sources. In a signal reconstruction step 322, the method 300 reconstructs the signals of interest to generate enhanced magnetic field measurements. The method 300 then provides for integration with a navigation system of the vehicle at 324, by feeding the enhanced magnetic field measurements to magnetic anomaly navigation algorithms in the navigation system.

Further details of the present approach are described hereafter in the following sections.

### Electromagnetic Interference (EMI) Problem

The EMI problem that is addressed by the present system and method can be represented by the following expression:

$${E}_{total} = {E}_{earth} + {E}_{platform} + {E}_{space / weather} + {E}_{anomaly}$$

where:
   Eₜₒₜₐₗ is the total magnetic scalar field (e.g., about 50,000 nT);
   Eₑₐᵣₜₕ is the contribution of the Earth magnetic field due to the core field of the Earth (e.g., about 40,000 nT);
   E_{platform} are the platform effects generated from the platform (e.g., about 10,000 nT);
   E_{space/weather} are the space/weather effects generated from external space and weather events (e.g., about 1-100 nT); and
   E_{anomaly} is the contribution of the Earth magnetic field due to magnetic anomalies of the Earth (e.g., about 250 nT).

As indicated above, platform effects such as from avionics and electronics in an aircraft generate magnetic artifacts that are significantly larger (e.g., about 10,000 nT) than magnetic anomaly signals of interest (e.g., about 250 nT).

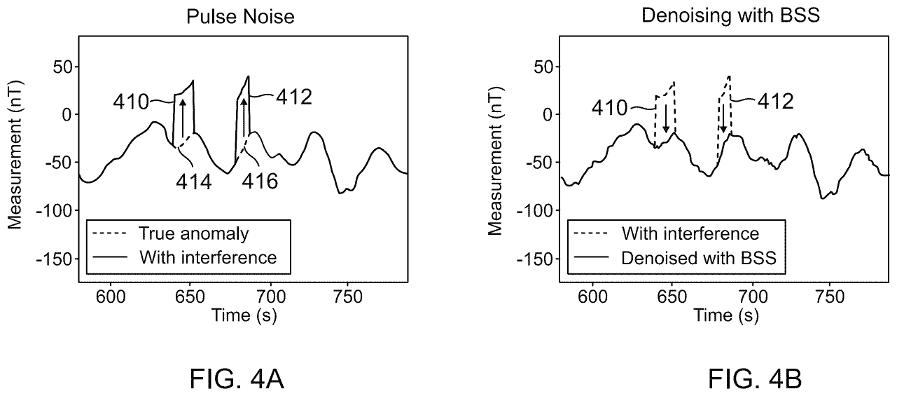

In addition, interference signals can reflect on the magnetometers with varying amplitudes. One way an interference signal can present itself is as an additive pulse noise. FIG. 4A is a graph of magnetometer measurements with respect to time, showing additive pulse noise signals 410 and 412, respectively over true anomaly signals 414 and 416.

### Blind Source Separation

The so called “cocktail party” problem, which is similar to the EMI problem, enables separation of interference sources with blind source separation (BSS) techniques. In the cocktail party problem, there are N observers, M independent sources, unknown source signals, and unknown mixing. This is a very undetermined problem, in that the sources and mixing are both unknown.

With the use of multiple magnetometers, this problem can be solved differently for magnetic anomaly navigation. In one approach, independent component analysis (ICA) can be utilized for separation of interference sources. The assumptions in this approach include: a linear mixing matrix; the source signals are independent of each other; and at most, one of the sources is Gaussian. If two of the sources are Gaussian, then the problem becomes unobservable. In addition, permutation and scale ambiguity exist.

One ICA algorithm is FastICA, which maximizes the non-Gaussianity of sources. In this method, as the independent sources are added together, they become more Gaussian. In addition, maximally non-Gaussian sources are likely to be independent as well. Thus, FastICA can be used to maximize non-Gaussianity and independence of sources. This approach requires at least as many observations as sources.

FIG. 4B is a graph of magnetometer measurements with respect to time, showing denoising with BSS of pulse noise signals 410 and 412 (from FIG. 4A). In simulations, there was a pulse root mean square error (RMSE) reduction from about 40 nT to about 4 nT with the use of three spatially separated magnetometers.

### Simulation Study

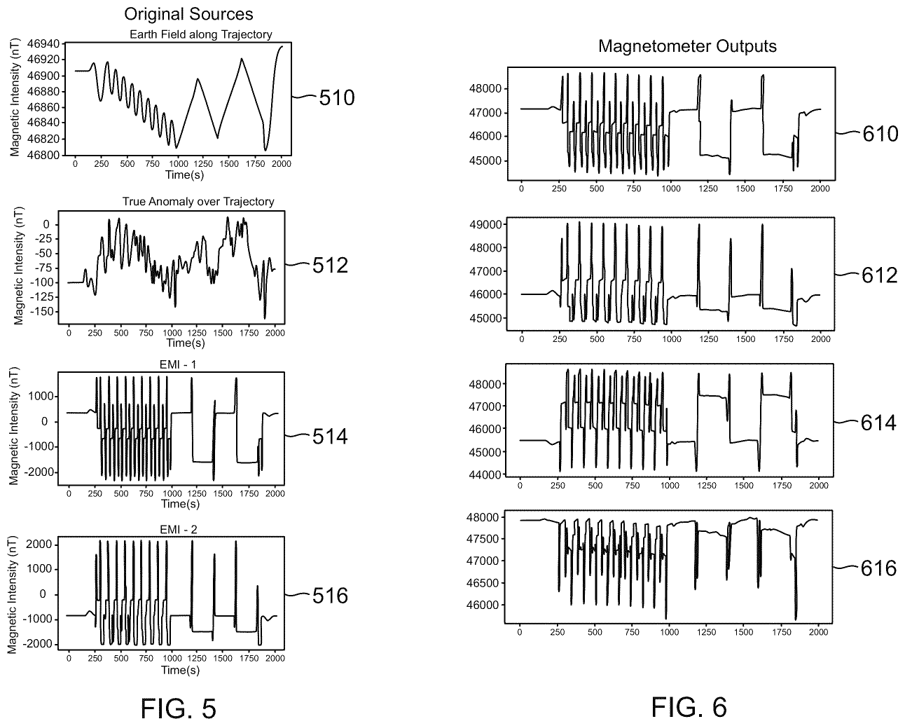

A simulation study was conducted that included various original sources, magnetometer outputs, and recovered sources. The original sources are represented by the graphs of FIG. 5, and include an Earth field along trajectory, as shown in a graph 510; a true anomaly over trajectory, as shown in a graph 512; a first EMI source from a vehicle, as shown in a graph 514; and a second EMI source from the vehicle, as shown in a graph 516.

The magnetometer outputs for four magnetometers are represented by the graphs of FIG. 6, including a graph 610, a graph 612, a graph 614, and a graph 616. In this simulation, only the outputs were used, with no Tolles Lawson or model information. In addition, there was linear mixing of unknown sources, but no dynamics.

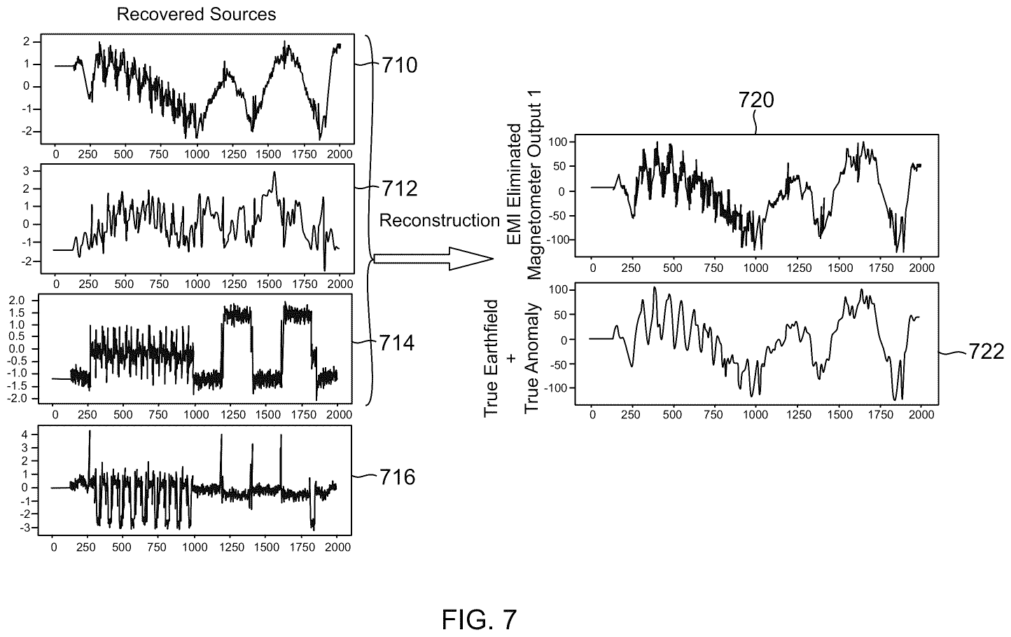

The recovered sources are represented in FIG. 7 by a first set of graphs 710, 712, 714, and 716. Sources were zeroed or removed, such as represented by graph 716, which were least correlated with the true earth field and the true anomaly. Signal reconstruction was performed using the recovered sources represented by graphs 710, 712, and 714, to generate enhanced magnetic field measurements represented by a second set of graphs 720 and 722. The graph 720 shows a plot of a magnetometer output with EMI eliminated, which is substantially similar to a plot of the true Earth field and true anomaly shown in the graph 722.

The processing units and/or other computational devices used in the systems and methods described herein may be implemented using software, firmware, hardware, or appropriate combinations thereof. The processing units and/or other computational devices may be supplemented by, or incorporated in, specially-designed application-specific integrated circuits (ASICs) or field programmable gate arrays (FPGAs). In some implementations, the processing units and/or other computational devices may communicate through an additional transceiver with other computing devices outside of the navigation system, such as those associated with a management system or computing devices associated with other subsystems controlled by the management system. The processing units and/or other computational devices can also include or function with software programs, firmware, or other computer readable instructions for carrying out various process tasks, calculations, and control functions used in the systems and methods described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### EXAMPLE EMBODIMENTS

Example 1 includes a system comprising: a vehicle; a navigation processing unit onboard the vehicle, the navigation processing unit including an Earth magnetic model, a sensor compensation module, a navigation filter, and a magnetic anomaly map storage; and a plurality of magnetometers onboard the vehicle and in operative communication with the sensor compensation module, the magnetometers spatially separated from each other; wherein the navigation filter hosts one or more magnetic anomaly navigation algorithms, the navigation filter in operative communication with the sensor compensation module and the magnetic anomaly map storage; wherein the sensor compensation module hosts a program module having instructions for performing a method to provide enhanced magnetic anomaly navigation for the vehicle, the method comprising: performing data acquisition by recording temporally synchronized magnetometer measurements from the magnetometers; performing blind source separation with a set of constraints including: a far-field assumption, in which a signal of interest that includes Earth magnetic field and a magnetic anomaly, is assumed to be measured quasi-identically across the magnetometers; and spatial coherence, which exploits known spatial relationships between the magnetometers to differentiate between global and local interference sources; performing interference source elimination to zero out or reduce irrelevant interference sources; reconstructing the signal of interest to generate enhanced magnetic field measurements; and feeding the enhanced magnetic field measurements to the one or more magnetic anomaly navigation algorithms in the navigation filter.

Example 2 includes the system of Example 1, wherein the instructions for performing the method further comprise: performing initial filtering of the magnetometer measurements to remove noise characteristics; normalizing the magnetometer measurements; and using Tolles-Lawson equations to mitigate some signal interference.

Example 3 includes the system of any of Examples 1-2, wherein the instructions for performing the method further comprise: performing source classification to classify separated interference sources.

Example 4 includes the system of any of Examples 1-3, further comprising one or more aiding sensors onboard the vehicle and in operative communication with the navigation filter.

Example 5 includes the system of Example 4, wherein the one or more aiding sensors comprise an inertial measurement unit (IMU).

Example 6 includes the system of Example 5, wherein the IMU includes one or more gyroscopes and one or more accelerometers.

Example 7 includes the system of any of Examples 5-6, wherein the IMU includes one or more micro-electromechanical systems (MEMS) gyroscopes and one or more MEMS accelerometers.

Example 8 includes the system of any of Examples 4-7, wherein the one or more aiding sensors comprise a global navigation satellite system (GNSS) receiver.

Example 9 includes the system of any of Examples 4-8, wherein the one or more aiding sensors comprise a vertical measurement device.

Example 10 includes the system of any of Examples 1-9, wherein the magnetometers include magnetometry structures using nitrogen-vacancy centers in diamond.

Example 11 includes the system of any of Examples 1-10, wherein the vehicle is an aerial vehicle.

Example 12 includes the system of any of Examples 1-10, wherein the vehicle comprises a crewed aircraft, or an uncrewed aircraft.

Example 13 includes the system of any of Examples 1-10, wherein the vehicle comprises a ground vehicle, or a water vehicle.

Example 14 includes a method comprising: obtaining temporally synchronized magnetometer measurements from a plurality of magnetometers onboard a vehicle, wherein the magnetometers are spatially separated from each other; performing blind source separation with a set of constraints including: a far-field assumption, in which a signal of interest that includes Earth magnetic field and a magnetic anomaly, is assumed to be measured quasi-identically across the magnetometers; and spatial coherence, which exploits known spatial relationships between the magnetometers to differentiate between global and local interference sources; performing interference source elimination to remove or reduce irrelevant interference sources; reconstructing the signal of interest to generate enhanced magnetic field measurements; and feeding the enhanced magnetic field measurements to one or more magnetic anomaly navigation algorithms in a navigation filter of the vehicle.

Example 15 includes the method of Example 14, wherein the method further comprises: performing initial filtering of the magnetometer measurements to remove noise characteristics; normalizing the magnetometer measurements; and using Tolles-Lawson equations to mitigate some signal interference.

Example 16 includes the method of any of Examples 14-15, wherein the blind source separation integrates one or more techniques comprising independent component analysis (ICA), an optimization algorithm, or an artificial neural network.

Example 17 includes the method of any of Examples 14-16, wherein the method further comprises performing source classification to classify separated interference sources as coming from an interference or noise, or not.

Example 18 includes the method of Example 17, wherein the source classification is performed using a trained machine learning algorithm, which performs techniques for automated classification of signals of interest and interference sources.

Example 19 includes the method of any of Examples 14-18, further comprising: obtaining sensor measurements from one or more aiding sensors onboard the vehicle and in operative communication with the navigation filter; and performing sensor measurement fusion in the navigation filter to include data from the one or more aiding sensors, thereby enhancing signal separation accuracy in real-time.

Example 20 includes the method of any of Examples 14-19, wherein the vehicle comprises an aerial vehicle, a ground vehicle, or a water vehicle.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system comprising:
a vehicle;
a navigation processing unit onboard the vehicle, the navigation processing unit including an Earth magnetic model, a sensor compensation module, a navigation filter, and a magnetic anomaly map storage; and
a plurality of magnetometers onboard the vehicle and in operative communication with the sensor compensation module, the magnetometers spatially separated from each other;
wherein the navigation filter hosts one or more magnetic anomaly navigation algorithms, the navigation filter in operative communication with the sensor compensation module and the magnetic anomaly map storage;
wherein the sensor compensation module hosts a program module having instructions for performing a method to provide enhanced magnetic anomaly navigation for the vehicle, the method comprising:
performing data acquisition by recording temporally synchronized magnetometer measurements from the magnetometers;
performing blind source separation with a set of constraints including:
a far-field assumption, in which a signal of interest that includes Earth magnetic field and a magnetic anomaly, is assumed to be measured quasi-identically across the magnetometers; and
spatial coherence, which exploits known spatial relationships between the magnetometers to differentiate between global and local interference sources;
performing interference source elimination to zero out or reduce irrelevant interference sources;
reconstructing the signal of interest to generate enhanced magnetic field measurements; and
feeding the enhanced magnetic field measurements to the one or more magnetic anomaly navigation algorithms in the navigation filter.

2. The system of claim 1, wherein the instructions for performing the method further comprise:
performing initial filtering of the magnetometer measurements to remove noise characteristics;
normalizing the magnetometer measurements; and
using Tolles-Lawson equations to mitigate some signal interference.

3. The system of claim 1, wherein the instructions for performing the method further comprise:
performing source classification to classify separated interference sources.

4. The system of claim 1, further comprising:
one or more aiding sensors onboard the vehicle and in operative communication with the navigation filter.

5. The system of claim 4, wherein the one or more aiding sensors comprise an inertial measurement unit (IMU).

6. The system of claim 5, wherein the IMU includes one or more gyroscopes and one or more accelerometers.

7. The system of claim 5, wherein the IMU includes one or more micro-electromechanical systems (MEMS) gyroscopes and one or more MEMS accelerometers.

8. The system of claim 4, wherein the one or more aiding sensors comprise a global navigation satellite system (GNSS) receiver.

9. The system of claim 4, wherein the one or more aiding sensors comprise a vertical measurement device.

10. The system of claim 1, wherein the magnetometers include magnetometry structures using nitrogen-vacancy centers in diamond.

11. The system of claim 1, wherein the vehicle is an aerial vehicle.

12. The system of claim 1, wherein the vehicle comprises a crewed aircraft, or an uncrewed aircraft.

13. The system of claim 1, wherein the vehicle comprises a ground vehicle, or a water vehicle.

14. A method comprising:
obtaining temporally synchronized magnetometer measurements from a plurality of magnetometers onboard a vehicle, wherein the magnetometers are spatially separated from each other;
performing blind source separation with a set of constraints including:
a far-field assumption, in which a signal of interest that includes Earth magnetic field and a magnetic anomaly, is assumed to be measured quasi-identically across the magnetometers; and
spatial coherence, which exploits known spatial relationships between the magnetometers to differentiate between global and local interference sources;
performing interference source elimination to remove or reduce irrelevant interference sources;
reconstructing the signal of interest to generate enhanced magnetic field measurements; and
feeding the enhanced magnetic field measurements to one or more magnetic anomaly navigation algorithms in a navigation filter of the vehicle.

15. The method of claim 14, wherein the method further comprises:
performing initial filtering of the magnetometer measurements to remove noise characteristics;
normalizing the magnetometer measurements; and
using Tolles-Lawson equations to mitigate some signal interference.

16. The method of claim 14, wherein the blind source separation integrates one or more techniques comprising independent component analysis (ICA), an optimization algorithm, or an artificial neural network.

17. The method of claim 14, wherein the method further comprises:
performing source classification to classify separated interference sources as coming from an interference or noise, or not.

18. The method of claim 17, wherein the source classification is performed using a trained machine learning algorithm, which performs techniques for automated classification of signals of interest and interference sources.

19. The method of claim 14, further comprising:
obtaining sensor measurements from one or more aiding sensors onboard the vehicle and in operative communication with the navigation filter; and
performing sensor measurement fusion in the navigation filter to include data from the one or more aiding sensors, thereby enhancing signal separation accuracy in real-time.

20. The method of claim 14, wherein the vehicle comprises an aerial vehicle, a ground vehicle, or a water vehicle.
